(19) United States
(12) Patent Application Publication
(10) Pub. No.: US 2023/0088830 A1
(43) Pub. Date: Mar. 23, 2023

(54) HYDROGEN DRONE CARRYING VEHICLE WITH HYDROGEN REFUELING SYSTEM AND COMMUNICATION SYSTEM

(71) Applicant: HyDaaS Inc., Englewood, NJ (US)

(72) Inventor: Steven KIM, Englewood, NJ (US)

(21) Appl. No.: 17/945,555

(22) Filed: Sep. 15, 2022

Related U.S. Application Data
(60) Provisional application No. 63/245,415, filed on Sep. 17, 2021.

(51) Int. Cl. B64F 5/40; B64C 39/02; B64F 1/28

(52) U.S. Cl. CPC B64F 5/40; B64C 39/024; B64F 1/28; B64C 2201/141; B64C 2201/18; B64C 2201/208; B64C 2201/042

(57) ABSTRACT

A mobile drone communication control station which has capabilities of fueling hydrogen or liquid hydrogen drone, communication control for the drone, communication to the remote pilot center and the edge computing system for analyzing the photos taken from the drone.

### CROSS-REFERENCE TO RELATED APPLICATION

This application claims priority to U.S. Provisional Patent Application No. 63/245,415, filed on Sep. 17, 2021, which is hereby incorporated by reference in its entirety.

### BACKGROUND

### Field of the Disclosure

The present disclosure relates to a hydrogen drone carrying vehicle with hydrogen refueling system and communication system.

### Description of the Background

A drone is rapidly utilized in a various industrial application such as filming, photography, inspection and maintenance, precision agriculture, mapping and surveying, surveillance and monitoring, etc. Under the strict the Federal Aviation Admiration (FAA) regulatory, there is a weight limitation for the drone. Weight less than 55 pounds is categorized as a small drone which has a relatively low regulatory restriction for operation of the drone under the Part 107 rule.

A lithium base battery is commonly used for a drone and a battery powered drone has a limited flight time of about 30 minutes in order to satisfy the weight limit of the small drone. On the other hand, a hydrogen fuel cell powered drone has a longer flying time of about 120 minutes. However, maintenance and refueling of the hydrogen drone is not as simple as a lithium battery powered drone.

For an efficient field service, a vehicle with capabilities of refueling hydrogen gas or liquid hydrogen on-site and communicating between a remote pilot center as well as between the drone, is necessary.

### SUMMARY

Accordingly, the present disclosure is directed to a hydrogen drone carrying vehicle with hydrogen refueling system and communication system that substantially obviates one or more of problems due to limitations and disadvantages of the prior art.

Additional features and advantages of the disclosure will be set forth in the description which follows and in part will be apparent from the description, or may be learned by practice of the disclosure. Other advantages of the present disclosure will be realized and attained by the structure particularly pointed out in the written description and claims hereof as well as the appended drawings.

To achieve these and other advantages and in accordance with the purpose of the present disclosure, as embodied and broadly described, A mobile drone communication control station system comprises a vehicle configured to carry a plurality of hydrogen or liquid hydrogen fuel cell drones and functioning as a communication base station; a 4G LTE antenna configured to communicate between a remote drone pilot center and a mobile drone station; a private WIFI network base station and a private WIFI antenna configured to control and communicate with the drones; a sliding drone take-off platform where the drones take off and land at the vehicle; hydrogen gas or liquid hydrogen tanks refueling the drones with a dispensing system; an edge computer configured to analyze photographs taken from the drones in a real time and receive data from the drones via the private WIFI network; a hydrogen refueling system configured to refuel the hydrogen gas or liquid hydrogen to the drones; and a lithium secondary battery supplying electricity to the communication base station, the edge computer and the hydrogen refueling system.

The lithium secondary battery may be charged by a fuel cell of the drones and a generator of the vehicle.

The hydrogen refueling system includes hydrogen and liquid hydrogen tanks, a compressor, hydrogen and liquid hydrogen dispenser for refueling the hydrogen gas or liquid hydrogen.

A sliding take-off and landing platform may be added to configure to slide in and out to take off or land the drones at the vehicle.

The sliding take-off and landing platform may have seat belts securing the drones while the vehicle is transporting the drones.

It is to be understood that both the foregoing general description and the following detailed description are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of the disclosure, illustrate aspects of the disclosure and together with the description serve to explain the principle of the disclosure.

In the drawings:

FIG. 1 is a drawing illustrating a vehicle including a mobile drone communication control station system; and

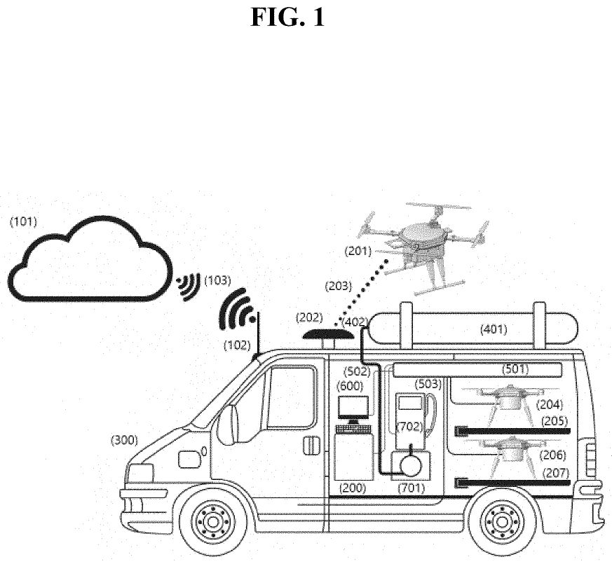

FIG. 2 is a drawing illustrating sliding take-off and landing platform with a seat belt for the drones in the present disclosure.

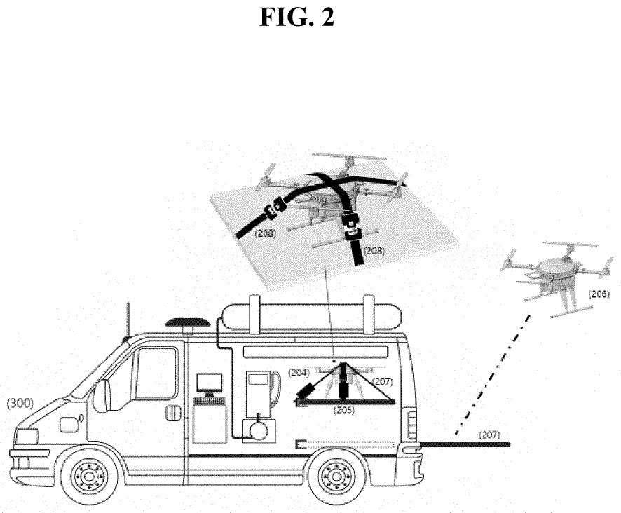

### DETAILED DESCRIPTION

Reference will now be made in detail to the aspects of the present disclosure, examples of which are illustrated in the accompanying drawings. Wherever possible, the same reference numbers will be used throughout the drawings to refer to the same or like parts.

For the hydrogen drone field service, a drone carrying vehicle which carries multiple drones with having capabilities of refueling hydrogen or liquid hydrogen as well as a communication system. The vehicle (300) carries the multiple drones (204), (206) and the sliding platform plates (205), (207) where the drones can take off and landing. The vehicle equipped with two communication systems; one is for communicating with a remote pilot center (101) via commercial 4G LTE network (103) and the other is a private WIFI (203) for communicating and control the drone. The vehicle carries a private WIFI base station (200) and an antenna (202). The vehicle has a hydrogen or liquid hydrogen refueling capability with the hydrogen gas or liquid hydrogen tanks (401), compressor (701) and dispenser unit (702). The vehicle has an edge computer (600) connected to the remote pilot center. Using an artificial intelligence software, the edge computer (600) analyzes the image data received from the drone (201) and selects the suspicious object image which will be then sent to the remote pilot center (101) where the detailed analysis is proceed by the human expert. The vehicle has a lithium secondary battery (501) to provide the power to the refueling and communication hardware systems. The battery is charged by the fuel cell of the drone (503) while the engine of the vehicle is stopped as well as by the generator of the vehicle while the engine is running,

It will be apparent to those skilled in the art that various modifications and variations can be made in the hydrogen drone carrying vehicle with hydrogen refueling system and communication system of the present disclosure without departing from the spirit or scope of the aspects. Thus, it is intended that the present disclosure covers the modifications and variations of the aspects provided they come within the scope of the appended claims and their equivalents.

### REFERENCE NUMERALS IN THE DRAWINGS

(101) A remote drone pilot center
(102) A mobile antenna for 4G LTE commercial network
(103) Communication using a commercial 4G LTE network
(200) A base station for a private WIFI
(201) A drone with a private WIFI receptor
(202) Antenna for private WIFI
(203) A private WIFI communication
(204) Drone #1
(205) Drone take off platform #1
(206) Drone #2
(207) Drone take off platform #2
(208) Seat belts for the drone
(300) A mobile drone communication control station (vehicle)
(401) Hydrogen gas or liquid hydrogen tanks
(402) A hydrogen supplying pipe to a hydrogen dispensing system
(501) A lithium secondary battery
(502) Electric output from lithium battery
(503) Charging input from the fuel cell of the drone and from the generator of the vehicle
(600) An edge computer with artificial intelligence based photo analyzing software
(701) Compressor
(702) Hydrogen dispenser

What is claimed is:

1. A mobile drone communication control station system, comprising:
a vehicle configured to carry a plurality of hydrogen or liquid hydrogen fuel cell drones and functioning as a communication base station;
a 4G LTE antenna configured to communicate between a remote drone pilot center and a mobile drone station;
a private WIFI network base station and a private WIFI antenna configured to control and communicate with the drones;
a sliding drone take-off platform where the drones take off and land at the vehicle;
hydrogen gas or liquid hydrogen tanks refueling the drones with a dispensing system;
an edge computer configured to analyze photographs taken from the drones in a real time and receive data from the drones via the private WIFI network;
a hydrogen refueling system configured to refuel the hydrogen gas or liquid hydrogen to the drones; and
a lithium secondary battery supplying electricity to the communication base station, the edge computer and the hydrogen refueling system.

2. The mobile drone communication control station system of claim 1, wherein the lithium secondary battery is charged by a fuel cell of the drones and a generator of the vehicle.

3. The mobile drone communication control station system of claim 1, wherein the hydrogen refueling system includes hydrogen and liquid hydrogen tanks, a compressor, hydrogen and liquid hydrogen dispenser for refueling the hydrogen gas or liquid hydrogen.

4. The mobile drone communication control station system of claim 1, further comprising a sliding take-off and landing platform configured to slide in and out to take off or land the drones at the vehicle.

5. The mobile drone communication control station system of claim 4, wherein the sliding take-off and landing platform has seat belts securing the drones while the vehicle is transporting the drones.
